(19) United States
(12) Patent Application Publication
(10) Pub. No.: US 2021/0041627 A1
(43) Pub. Date: Feb. 11, 2021

(54) ENHANCED PHOTONIC ASSEMBLY

(71) Applicant: General Electric Company, Schenectady, NY (US)

(72) Inventors: Joleyn Eileen Brewer, Clifton Park, NY (US); James Wilson Rose, Guilderland, NY (US)

(21) Appl. No.: 16/536,029

(22) Filed: Aug. 8, 2019

(51) Int. Cl. G02B 6/13

(52) U.S. Cl. CPC G02B 6/13

(57) ABSTRACT

This disclosure generally relates to systems and methods for improving adhesive bonding between a layer of a device that transmits optical signals, such as a photonics integrated circuit, and a waveguide that helps to transmit at least some of the optical signals. Adhesion methods may include using vapor-phase encapsulation, capillary underfill, or compressive displacement to secure the waveguide to at least one layer of the device that transmits optical signals. In each of these methods, the adhesion method may create an adhesive interface between at least a portion of the waveguide and a contacting layer of the device that transmits optical signals.

### STATEMENT REGARDING FEDERALLY SPONSORED RESEARCH & DEVELOPMENT

This invention was made with Government support under contract number FA8650-15-2-5220 awarded by the Air Force Research Laboratory. The Government has certain rights in the invention.

### BACKGROUND

The subject matter disclosed herein relates to systems and methods for improving bonding between at least one layer of a photonic integrated circuit device and a waveguide.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In optical sensing systems, an optical sensing system may generate a light from a laser source, transmit the light through a waveguide to an external sensor, and sense (or estimate) a wavelength of the light received from the external sensor. The sensed wavelength may be analyzed by a computing device of the optical sensing system and used to determine a parameter at the location of the sensor. While useful, these optical sensing systems are sometimes exposed to strain, vibrations, and are typically large, bulky, and expensive pieces of equipment.

### BRIEF DESCRIPTION

Certain embodiments commensurate in scope with the originally claimed disclosure are summarized below. These embodiments are not intended to limit the scope of the claimed disclosure, but rather these embodiments are intended only to provide a brief summary of possible forms of the disclosure. Indeed, embodiments may encompass a variety of forms that may be similar to or different from the embodiments set forth below.

In one embodiment, a device may include a first layer having a substrate. The device may also include a waveguide layer. The waveguide layer may include at least two deposited formations. A respective formation of the at least two deposited formations may be characterized by a first width. The waveguide layer may be formed at least partially on the first substrate. The device may also include a second layer formed on the waveguide layer and an intervening adhesion layer. The intervening adhesion layer may be formed at least partially between the waveguide layer and the second layer. The intervening adhesion layer may be characterized by a second width. The second width may be greater than the first width.

In another embodiment, a method may include forming a waveguide on a first layer and forming a second layer. The second layer may include a magneto-optic layer. The method may include adhering the second layer to the waveguide via an intervening adhesion layer characterized by a width that exceeds a width of the waveguide. The method may also include forming a photonic integrated circuit device that includes the waveguide, the second layer, and the intervening adhesion layer.

In yet another embodiment, a device may include a first layer. The first layer may include a waveguide having a first width. The device may include a second layer that includes an epoxy having a second width. The second width may be greater than the first width. The device may also include a third layer disposed on the second layer and the first layer. The second layer may be coupled between the first layer and the third layer via at least two fillets.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective cross-sectional view of a photonic device disposed within an optical sensing system or other photonic circuitry, in accordance with aspects of the present approach;

FIG. 2 is a perspective cross-sectional view of a second example waveguide of the optical sensing system, in accordance with aspects of the present approach;

FIG. 3 is a perspective cross-sectional view of a third example waveguide of the optical sensing system, in accordance with aspects of the present approach;

FIG. 4A is a cross-sectional view of a fourth example waveguide of the optical sensing system before assembly, in accordance with aspects of the present approach;

FIG. 4B is a cross-sectional view of the fourth example waveguide of FIG. 4A after assembly, in accordance with aspects of the present approach; and

FIG. 5 is a flow chart of a method of manufacturing the optical sensing system, in accordance with aspects of the present approach.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. One or more specific embodiments of the present embodiments described herein will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Embodiments of the present disclosure are related to bonding techniques to be used in manufacturing of integrated photonic circuitry. Generally, an optical sensing system may include one or more dedicated light sources and/or laser generation devices, optical receivers, and/or other optical components and equipment. However, optical sensing system equipment may be large, cumbersome, and/or expensive. Integrating the optical sensing system onto an integrated photonic circuit may enable increasingly complex optical and electrical circuits to be packed into smaller volumes and/or smaller footprints (e.g., smaller relative to current nonintegrated optical equipment).

An integrated photonic circuit may include various active structures such as one or more light sources, one or more modulators, one or more tunable filters, one or more photodiodes, one or more electronic chips, or the like. The integrated photonic circuit may also include various passive structures such as one or more waveguide structures, one or more splitters, one or more Mach Zehnder interferometers, one or more Bragg gratings (e.g., spiral Bragg gratings), one or more ring filters, one or more edge filters, or the like. The active features and/or the passive features may sometimes need to exchange light signals to complete processing of the light signals and/or data. In these cases, one or more waveguides may be used to guide the light signals between components.

Keeping this in mind, equipment of the optical sensing system may be exposed to strain either from its size, weight, and/or environment within which the optical sensing system is used. In this way, adhesives used to secure a waveguide to at least one layer within the integrated photonic circuit may be subjected to strain over time and/or use. Thus, it may be desired to increase a mechanical shear strength of the bond coupling the waveguides to the component to improve resiliency of the integrated photonic circuit to strain.

Furthermore, current engineering standards define a minimum acceptable shear strength for a reliable and/or desired bond between two layers of the integrated photonic circuit as withstanding a minimum force of 0.04 kilograms (kg) for each one ten-thousandth square inch. Current manufacturing techniques generally do not create bonds between the two layers that pass these standards.

Embodiments of the present disclosure describe systems and methods that help increase mechanical shear strength of the bonding used to join a waveguide to at least one layer within the integrated photonic circuit of the optical sensing system. The system and methods may include techniques that leverage vapor phase encapsulation techniques, capillary underfill of liquid epoxy techniques, and/or compressive displacement of liquid epoxy techniques to improve the mechanical shear strength of the bond of the waveguide.

As described herein, specific examples of materials may be referenced. However, it should be understood that any suitable material for each technique may be used and applied herein with the systems and methods described. When using the systems and methods described herein in a design, particular benefits may be afforded to the design. For example, increasing a mechanical shear strength of the adhesive bonding of the waveguides may increase reliability of the waveguide, the component, and/or the optical sensing system. Furthermore, increasing the mechanical shear strength of the adhesive bonding may also improve the optical coupling of the waveguides and/or reduce the likelihood of the waveguide, the component, and/or the optical sensing system experiencing environmental degradation over time.

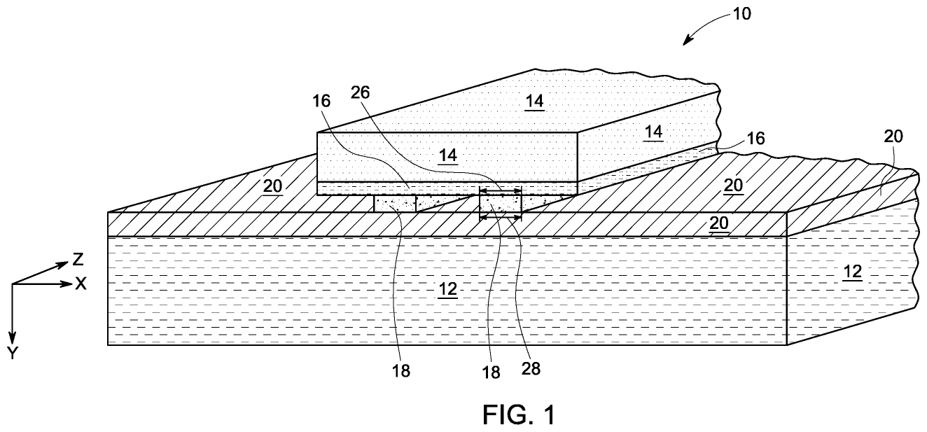

By way of introduction, FIG. 1 is a perspective cross-sectional view of a photonic device 10 that may be disposed within an optical sensing system or other photonic circuitry. The photonic device 10 includes a photonic integrated circuit (PIC) 12. The PIC 12 may be processed circuitry (e.g., a formed device) and/or may represent an intermediary manufacturing product of the formed device. It should be understood that, although not explicitly described, the systems and methods described herein may be applied to a variety of photonic or optical circuitry devices to improve shear strength between components. This may include layers within the photonic device 10 in addition to or alternative to the layers depicted and described below.

The PIC 12 may interface with additional components via a carrier substrate 14. The photonic device 10 may include the carrier substrate 14, which may be formed from and/or include gadolinium gallium garnet-based compounds (e.g., substituted gadolinium gallium garnet (SGGG)). The carrier substrate 14 may be disposed on a magneto-optic layer 16, such as a layer (e.g., film) of cerium-substituted yttrium iron garnet (Ce:YIG). The magneto-optic layer 16, formed on carrier substrate 14, couples with light or optical signals transmitted through the waveguides 18 situated on the PIC 12.

Generated optical signals may transmit via a waveguide 18 (e.g., a waveguide layer) disposed between the magneto-optic layer 16 and the PIC 12. It is noted that although depicted as two waveguides, additional waveguides, such as another suitable waveguide structure and/or a waveguide similar to the waveguides 18, may be included in either direction along the x-axis.

The waveguides 18 may be deposited to form two or more parallel mesa structures between the PIC 12 and the magneto-optic layer 16. During manufacturing, the waveguides 18 and the magneto-optic layer 16 may be attached together via direct bonding techniques that may not use covalent bonding between layers or pressure. When the photonic device 10 is manufactured, air (e.g., air bubbles, air gaps) or other contaminants may be trapped at the interface between the waveguides 18 and the magneto-optic layer 16. Furthermore, a sheer strength of the direct bond between the waveguides 18 and the magneto-optic layer 18 may degrade during use of the photonic device 10 and provide undesirably low amounts of sheer strength between the layers.

As described herein, this present disclosure relates to several systems and methods that may be used during manufacturing of the photonic device 10 to secure the waveguides 18 between the magneto-optic layer 16 and the PIC 12 (e.g., via the oxide layer 20) that improve sheer strength between layers of the photonic device 10. For example, the systems and methods described herein leverage vapor phase encapsulation techniques, capillary underfill of liquid epoxy techniques, and/or compressive displacement of liquid epoxy techniques to improve a shear strength between layers of the photonic device 10 while decreasing a likelihood of contaminants or air changing an index of refraction (n) associated with the waveguides 18.

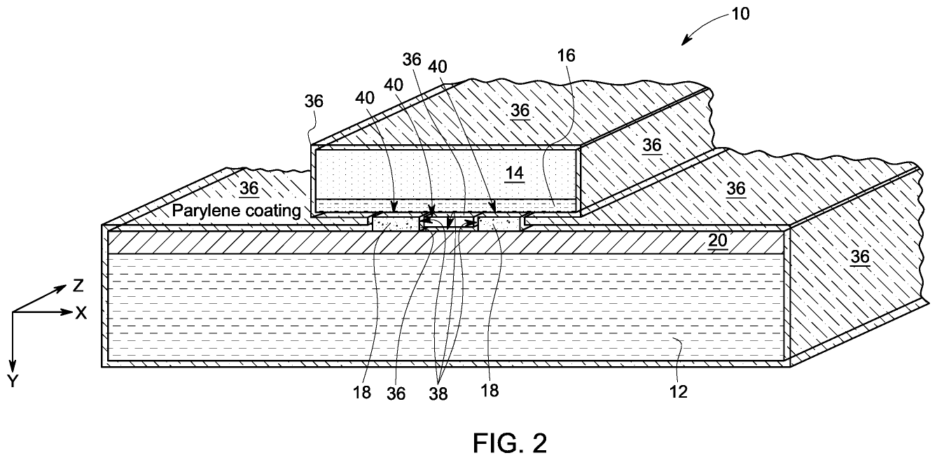

To help explain, FIG. 2 is a perspective cross-sectional view of an example of the photonic device 10 that uses a vapor-phase encapsulation to secure the waveguides 18 between the magneto-optic layer 16 and the oxide layer 20. During a vapor-phase encapsulation, a device may be coated by a compound in a vapor state (e.g., gas state or phase, gaseous state or phase). In some embodiments, the vapor-phase encapsulation may result in a coating of substantially uniform thickness around the device (e.g., a few angstroms to several microns, between 10 and 500 nanometers (nm)).

In the depicted example, the vapor-phase encapsulation uses parylene to coat the photonic device 10. Parylene deposition may be performed by condensation of a cracked dimer in a vacuum system. While in a vacuum system, the photonic device 10 and an ambient atmosphere within the vacuum system (e.g., within a vacuum chamber of the vacuum system) may be devoid of air, or include a negligible amount of air. Thus, the vapor-phase encapsulation of parylene within the vacuum system may reduce or eliminate a likelihood that a contaminant (e.g., air) is captured in bonding between the magneto-optic layer 16 and the waveguides 18.

The photonic device 10 assembly may be placed in a vacuum deposition reactor subsequent to placing the magneto-optic layer 16 on the PIC 12 and waveguides 18. Following evacuation of ambient atmosphere from the vacuum deposition reactor, a process of chemical vapor deposition (CVD) or other suitable vapor-deposition process may take place. Parylene may be applied to the photonic device 10 during the CVD or other suitable vapor-deposition process. After the CVD or vapor-deposition process completes, a coating may encapsulate the surfaces of the photonic device 10. In the depicted example, a parylene coating 36 encapsulates the surfaces of the photonic device 10 exposed to the ambient atmosphere within the vacuum system. By nature of the CVD process, this deposit fills exposed paths, including any gaps between the waveguides 18 and the magneto-optic layer 16. In this way, the encapsulated surfaces may include surface faces of the photonic device 10 assembly, in addition to inner surfaces of the waveguides 18 (e.g., represented via arrows 38) as well as inner surfaces of the magneto-optic layer 16 (e.g., represented via arrows 40). The parylene coating 36 may deposit into surface inconsistencies (e.g., such as a gap between a surface of the waveguides 18 and a surface of the magneto-optic layer 16, scratches) at a submicron scale. In this application, the parylene deposition is expected to coat any portion of the magneto-optic layer 16 and the waveguide 18 interface not in intimate contact. In this way, the parylene coating 36 may be deposited on a first face of the magneto-optic layer 16, on a second face of the oxide layer 20, and on the waveguides 18 interfacing between the first face and the second face. Once applied, the parylene coating 36 bonds the waveguides 18 and the magneto-optic layer 16.

Parylene may have an index of refraction between n=1.661 and n=1.669. Various grades of parylene may be used including N-grade, C-grade, and/or D-grade. Parylene may act as a moisture and/or dielectric barrier to protect the photonic device 10 while bonding the waveguides 18 between the magneto-optic layer 16 and oxide layer 20. It is noted that although parylene is well-suited for use in optical applications to secure the layers, any suitable organic or inorganic compound able to be deposited via CVD, or another suitable vapor-phase encapsulation process, that is also suitable for optical applications may be used instead of or with the parylene.

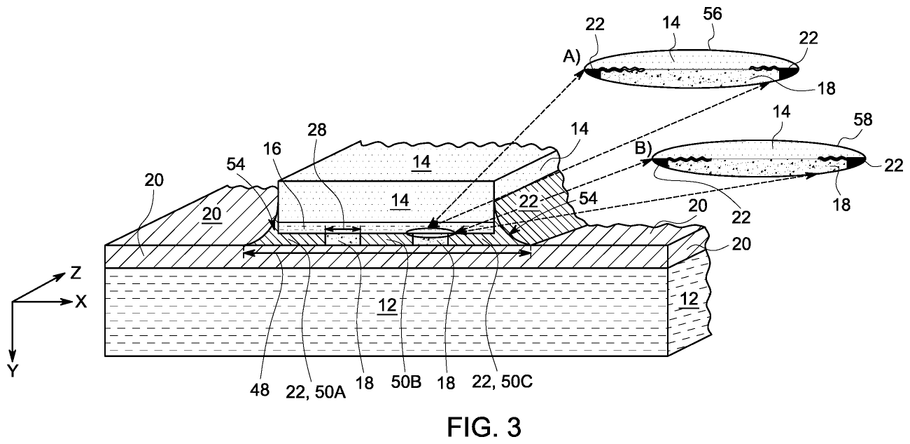

Although vapor-phase encapsulation is an option for securing the waveguides 18 between the magneto-optic layer 16 and oxide layer 20, FIG. 3 is perspective cross-sectional view of an example of the photonic device 10 that uses capillary underfill of liquid epoxy 22 to secure the waveguides 18 between the magneto-optic layer 16 and the oxide layer 20. Capillary underfill methods may be relatively more cost-effective to implement relative to vapor-phase encapsulation methods. To leverage capillary underfill of liquid epoxy 22 methods, the photonic device 10 may be assembled before liquid epoxy 22 is applied to the end openings of the waveguides 18 of the photonic device 10. An optically-transparent, low viscosity epoxy may be used as the liquid epoxy 22, such as EPO-TEK 310-2 (e.g., n=1.532) or any suitable epoxy having an index of refraction between n=1.5 and n=1.7 (e.g., n=1.5, n=1.5-1.7). After deposition of the liquid epoxy, a layer of the liquid epoxy 22 may have a width 48 that is greater than the width 28 of at least a portion of the waveguides 18. It is noted that in some cases, the magneto-optic layer 16 may be formed on the carrier substrate 14 and/or the waveguide 18 may be formed in the oxide layer 20 before deposition of the liquid epoxy 22. The liquid epoxy 22 may be deposited on the waveguide 18 before the magneto-optic layer 16 is bonded to the waveguide 18.

For the purpose of the present explanation, the photonic device 10 extends a particular length in the z-axis direction. The depicted cross-section of the photonic device 10 may be presumed to be an intersection of the length of the photonic device 10, and in this way at some point in both the −z-direction and the +z-direction, the waveguides 18 (as well as the other layers) ends. Liquid epoxy 22 may be deposited at one or both ends to the waveguides 18. Surface tension and/or physical properties of the liquid epoxy 22 may draw the liquid epoxy 22 into regions 50 between the fillets 54 and waveguides 18 (e.g., region 50A, region 50B, region 50C). In this way, a volume of liquid epoxy 22 used during deposition may be large enough to fill the regions 50. These same properties may also cause formation of fillets 54. In this embodiment, a surface area used for bonding may be greater than bonds described in FIG. 1 and FIG. 2, which improves bond strength of the bond. The fillets 54 may improve contact strength of the adhesion of the liquid epoxy 22, and thus may help to improve the shear strength of the photonic device 10. The liquid epoxy 22 may flow into surface inconsistencies (e.g., such as a gap between a surface of the waveguides 18 and a surface of the magneto-optic layer 16, scratches), and therefore may eliminate or reduce surface inconsistencies between the waveguides 18 and the magneto-optic layer 16.

Sub-plot 56 and sub-plot 58 both depict an interface between structures of the waveguides 18 and the magneto-optic layer 16 after application of the liquid epoxy 22. The sub-plot 58 depicts an example where the photonics device 10 is in a vacuum chamber during the application of the liquid epoxy 22. Comparing the sub-plot 56 to the sub-plot 58, applying the liquid epoxy 22 to the photonics device 10 under vacuum ambient conditions (e.g., no air in the vacuum chamber) may improve and reduce an amount of air remaining within the interface between the waveguides 18 and the magneto-optic layer 16. In this way, vacuum backfill application of the liquid epoxy 22 may improve a penetration of the liquid epoxy 22 into the interface between the waveguides 18 and the magneto-optic layer 16. When foreign compounds (e.g., air, contaminants) are included at the interface, an index of refraction (n) characterizing at least a portion of the liquid epoxy 22 may change from a known value to an unknown value or otherwise undesirable value. Furthermore, since some materials of the photonic device 10 are rigid (e.g., crystalline) materials, deviation from planarity of mating surfaces between layers may result in air gaps and degrade performance. Thus, by manufacturing the photonic device 10 using methods that reduce the foreign compounds and/or improve a bond, performance of the photonic device 10 may improve.

It is noted that in general, optical signal transmission may be more efficient and/or of higher signal integrity when the optical signal transmits through materials of same or substantially similar indices of refraction and/or when air gaps are minimized or eliminated at an interface between mating surfaces. For example, an optical signal transmitting from a layer characterized by an index of refraction n=2 may transmit with relatively less signal integrity into a layer characterized by an index of refraction n=1 relative to a transmission into a layer characterized by an index of refraction, n=1.5. In this way, the particular compound used as an adhesive between layers may be selected particularly for the layers of the photonic device 10, and thus deviation from the known index of refraction of the adhesive may be reduced or minimized.

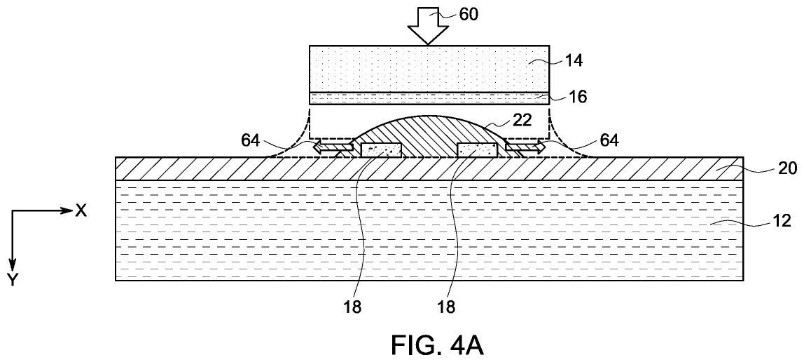

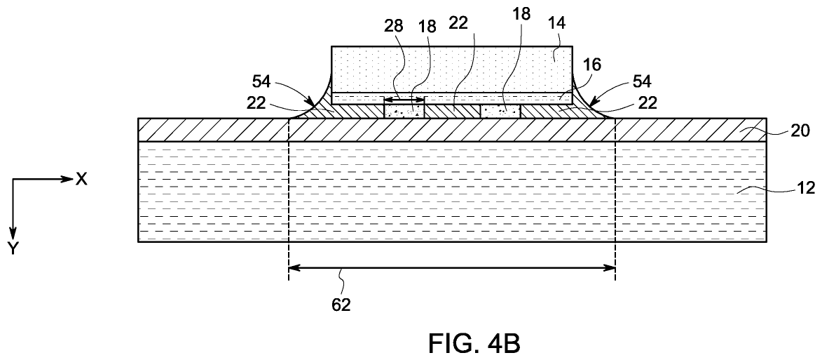

In this manufacturing method, the layers (e.g., the carrier substrate 14, the magneto-optic layer 16, the waveguides 18, the oxide layer 20, and the PIC 12) may be assembled before the liquid epoxy 22 is applied. This may be in contrast to the methods described in FIG. 4, which leverage a deposition of the liquid epoxy 22 before assembly of at least two layers as a method of manufacturing to improve shear strength of the photonic device 10. In both example methods, a flow of the liquid epoxy 22 beyond a perimeter of the magneto-optic layer 16 results in the fillet 54 (e.g., adhesive fillet). This fillet and the greater bonded surface area may improve mechanical strength of the photonic device 10 assembly.

FIG. 4A is perspective cross-sectional view of an example of the photonic device 10 that uses a deposition of liquid epoxy 22 before assembly of at least two layers to secure the waveguides 18 between the magneto-optic layer 16 and the oxide layer 20 at a first time of manufacturing while FIG. 4B is a perspective cross-sectional view of the photonics device 10 at a second time of manufacturing. The liquid epoxy 22 may be applied to one or more portions of the photonic device 10 before some layers of the photonic device 10 are assembled. Compressive pressure (represented via arrow 60) applied to the photonic device 10 after application of the liquid epoxy 22 and assembly of the layers of the photonic device 10 displaces any air or contaminants at the interface between the waveguides 18 and the magneto-optic layer 16. Similar to the capillary underfill method, an optically-transparent, low viscosity epoxy may be used as the liquid epoxy 22, such as EPO-TEK 310-2 (e.g., n=1.532) or any suitable epoxy having an index of refraction between n=1.5 and n=1.7 (e.g., n=1.5, n=1.5-1.7). It is noted that the liquid epoxy 22 used in compressive displacement methods may have a viscosity similar to water (H₂O). In addition, it is noted that compressive displacement methods may be relatively more cost-effective to implement relative to vapor-phase encapsulation methods.

Similar to the capillary underfill method, the liquid epoxy 22 may flow into surface inconsistencies (e.g., such as a gap between a surface of the waveguides 18 and a surface of the magneto-optic layer 16, scratches), and therefore may eliminate or reduce air gaps caused by surface inconsistencies between the waveguides 18 and the magneto-optic layer 16. After deposition of the liquid epoxy, a layer of the liquid epoxy 22 may have a width 62 that is greater than the width 28 of at least a portion of the waveguides 18.

The photonic device 10 may be partially assembled when the liquid epoxy 22 is applied. For example, the magneto-optic layer 16 may be formed on the carrier substrate 14 and/or the waveguides 18 may be formed in the oxide layer 20 before deposition of the liquid epoxy 22. The liquid epoxy 22 may be deposited on the waveguides 18 before the magneto-optic layer 16 is bonded to the waveguides 18. When a physical pressure, such as a compression, is applied to the carrier substrate 14 after layering the carrier substrate 14 and magneto-optic layer 16 on the waveguides 18 (with the liquid epoxy 22 intervening), the liquid epoxy 22 displaces to adhere the waveguides 18 to the surface of the magneto-optic layer 16. The physical pressure may cause the liquid epoxy 22 to spread across the surface of the magneto-optic layer 16 to fill in any air gaps (represented via arrows 64), or contaminants, between the waveguides 18 and the magneto-optic layer 16. Any additional volume of liquid epoxy 22 may form fillets 54 along the physical edges of the magneto-optic layer 16 and/or the carrier substrate 14. The fillets 54, similar to the fillets 54 of FIG. 3, may also increase a shear strength of the photonic device 10.

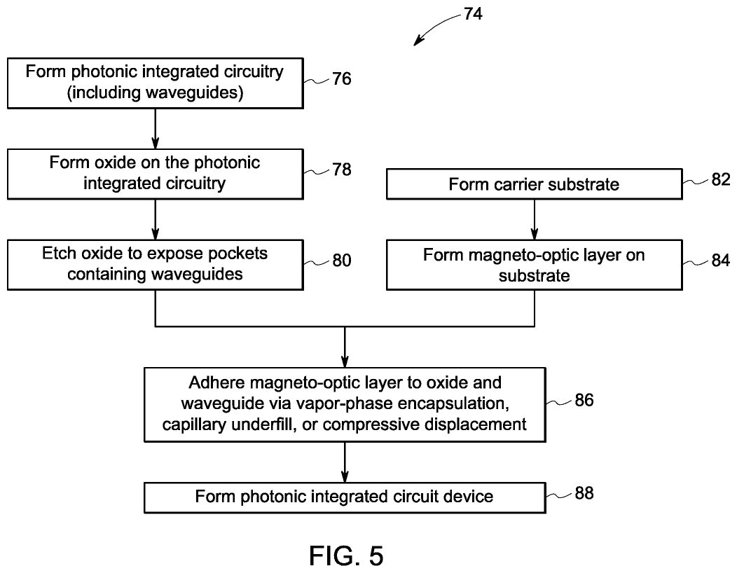

These manufacturing methods may be summarized and described as improved adhesion methods. FIG. 5 is a flow diagram of a process 74 for forming the photonic device 10 of FIGS. 2, 3, and 4B using one of the adhesion methods described above. It should be noted that the illustrated embodiment of the process 74 is merely provided as an example, and in other embodiments, the process 74 may include additional steps, repeated steps, or fewer steps, in accordance with the present disclosure. Additionally, FIG. 5 is discussed with reference to features described above, for example, features of the photonic device 10.

For the illustrated embodiment, the process 74 begins with, at block 76, forming the PIC 12 on a base substrate. In certain embodiments, vapor-phase, liquid-phase, or solid-phase epitaxial growth techniques may be used instead of or in combination with photonics circuitry manufacturing techniques to provide the PIC 12. The PIC 12 may include a base substrate with one or more additional optical circuitry or photonics integrated circuitry embedded, deposited on, or otherwise associated with the base substrate. Circuitry of the PIC 12 may communicatively couple to processing circuitry to perform sensing operations and/or control operations. In this way, the PIC 12 may also include input/output circuitry to facilitate transmission of data between the PIC 12 and additional systems.

The process 74 continues with, at block 78, forming the oxide layer 20 on the PIC 12. After the oxide layer 40 is formed, the process 74 continues with, at block 80, etching the oxide layer 20 to expose pockets that include the waveguides 18. The oxide layer 20 and/or the waveguides 18 may be formed using a combination of epitaxial growth and/or etching techniques. In this way, one or more blocking masks may be used when forming the oxide layer 20 and/or when etching the waveguides 18 into the oxide layer 20.

The process 74 continues with, at block 82, forming the carrier substrate 14 and, at block 84, forming the magneto-optic layer 16 on the carrier substrate 14. As described above, the carrier substrate 14 may be formed from gadolinium gallium garnet-based compounds, such as substituted gadolinium gallium garnet (SGGG). The magneto-optic layer 16 may include a layer of cerium-substituted yttrium iron garnet (Ce:YIG). The carrier substrate 14 and/or the magneto-optic layer 16 may interface with additional photonic circuitry that generate light or optical signals for transmission to the PIC 12. The carrier substrate 14 may be used to enable handling of and lattice matched growth of the magneto-optic layer 16. Instead of using bulk Ce:YIG to form the magneto-optic layer 16, a thin film may be grown or deposited on the carrier substrate 14. The carrier substrate may be chosen to have lattice constant closely matching the Ce:YIG of the magneto-optic layer 16, thus reducing defects. Reducing defects at the interface between the magneto-optic layer 16 and the carrier substrate 14 may improve transmission efficiencies.

At block 86, the process 74 continues with adhering the magneto-optic layer 16 to the oxide layer 20 and/or the waveguides 18 via vapor-phase encapsulation, capillary underfill, or compressive displacement methods. Operations of block 86 may include removing ambient air from a vacuum cavity and/or placing the portions of the photonic device 10 into a vacuum cavity for bonding. The operations of block 86 may also include depositing parylene on all faces of the bonded the magneto-optic layer 16 and carrier substrate 14 (minus an interfacing layer between the magneto-optic layer 16 and carrier substrate 14), on at least two faces of the waveguides 18, and at least three faces of the bonded oxide layer 20 and PIC 12. Furthermore, depositing parylene may include performing condensation operations when operating a vacuum. Bonding between the magneto-optic layer 16, the oxide layer 20, and the waveguides 18 may promote optical transmission between the layers of the photonic device 10. In this way, these methods may minimize a change between indices of refraction between the layers of the photonic device 10.

At block 88, the process 74 continues with forming a photonic integrated circuit device using the photonic device 10. This may include performing a curing operation to finalize and/or cure the liquid epoxy 22. After adhering the magneto-optic layer 16, the oxide layer 20, and the waveguides 18, various oxides and/or materials may be implanted, deposited, or otherwise disposed within, near, or around the photonic device 10 to complete formation of the photonic integrated circuit device via additional or alternative steps to the steps described herein to reach a final device structure or circuitry structure. In addition, it is noted that operations of blocks 76, 78, and 80 may be performed at least partially in parallel to operations of blocks 82 and 84. These operations may be performed before operations of blocks 86 and 88.

Technical effects of this disclosure includes methods of manufacturing to improve shear strength of an integrated photonics device. In particular, these methods described herein may improve adhesion between a waveguide layer and an additional layer of a photonics device. As described herein, the additional layer is a magneto-optic layer, however, it should be understood that these methods may be used with a variety layers to adhere one or more waveguides associated with a waveguide layer of a photonics device to another layer. Adhesion methods may include using vapor-phase encapsulation, capillary underfill, or compressive displacement to secure at least one waveguide to at least one layer of a photonics device. In each of these methods, the adhesion method may create an adhesive interface between at least a portion of the waveguides and a contacting layer of photonics device. At least portion of the adhesive interface may have a width (e.g., x-axis direction) equal to a width of a contacting layer of the photonics device that extends beyond the width of the at least a portion of the waveguide. Some adhesive interfaces may also include formation of a fillet. Each of the systems and methods described herein benefit from a whole encapsulation of contacting surfaces between the magneto-optic layer and the waveguide. Certain materials of the magneto-optic layer may benefit particularly from the prevention of ingress of atmospheric species over time, for example a magneto-optic layer formed from Ce:YIG. Encapsulation of exposed Ce:YIG surfaces, as described herein, may abate migration of atmospheric species along the described contacting surfaces. Performance integrity may be maintained or degradation slowed when atmospheric specifics, like water (H₂O), hydrogen sulfide (H₂S), or sulfate (SO₄), are prevented from migrated into surface roughness or gaps.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A device, comprising:
a first layer comprising a substrate;
a waveguide layer comprising at least two deposited formations, wherein a respective formation of the at least two deposited formations comprises a first width, and wherein the waveguide layer is formed at least partially on the first layer;
a second layer formed on the waveguide layer; and
an intervening adhesion layer formed at least partially between the waveguide layer and the second layer, wherein the intervening adhesion layer comprises a second width, wherein the second width is greater than the first width, and wherein the intervening adhesion layer comprises a fillet formed along a physical edge of the second layer and at least partially along a physical edge of the first layer.

2. The device of claim 1, wherein the intervening adhesion layer comprises parylene.

3. The device of claim 1, wherein the second layer comprises cerium-substituted yttrium iron garnet (Ce:YIG).

4. The device of claim 1, wherein the intervening adhesion layer is associated with at least two fillets.

5. The device of claim 1, comprising an oxide layer, wherein the waveguide layer is formed into the oxide layer.

6. The device of claim 1, wherein the first layer comprises photonics integrated circuitry.

7. The device of claim 1, wherein the intervening adhesion layer is configured to be formed in a vacuum.

8. The device of claim 1, wherein the intervening adhesion layer comprises a compound characterized by an index of refraction between 1.5 and 1.7.

9. The device of claim 1, wherein the intervening adhesion layer comprises an epoxy.

10. A method, comprising:
forming a waveguide on a first layer;
forming a second layer that comprises a magneto-optic layer;
adhering the second layer to the waveguide via an intervening adhesion layer characterized by a width that a width of the waveguide, wherein the intervening adhesion layer comprises a fillet formed along an entire physical edge of the second layer; and
forming a photonic integrated circuit device that comprises the waveguide, the second layer, and the intervening adhesion layer.

11. The method of claim 10, comprising:
removing ambient air from a vacuum cavity; and
performing at least the adhering the second layer to the waveguide in the vacuum cavity.

12. The method of claim 11, wherein the adhering the second layer to the waveguide comprises:
placing the second layer on the waveguide; and
depositing epoxy at an edge of the waveguide after placement of the second layer on the waveguide.

13. The method of claim 11, wherein the adhering the second layer to the waveguide comprises:
depositing parylene on a first face of the first layer, a second face of the second layer, and the waveguide interfacing between the first face and the second face, wherein the first face is opposite the second face.

14. The method of claim 13, wherein the depositing of parylene comprises performing condensation operations.

15. The method of claim 10, wherein the adhering the second layer to the waveguide comprises:
depositing epoxy on the waveguide; and
applying a compressive pressure to the second layer, wherein the intervening adhesion layer is formed after applying of the compressive pressure.

16. A device comprising:
a first layer comprising a waveguide having a first width;
a second layer comprising an epoxy having a second width, wherein the second width is greater than the first width; and
a third layer disposed on the second layer and the first layer, wherein the second layer is coupled between the first layer and the third layer, and wherein the second layer has a fillet formed along a physical edge of the third layer.

17. The device of claim 16, wherein the second layer is coupled between the first layer and the third layer via at least two fillets.

18. The device of claim 16, wherein the epoxy is characterized by an index of refraction between 1.5 and 1.7.

19. The device of claim 16, wherein epoxy is deposited to form the second layer before the third layer is disposed on the second layer and the first layer.

20. The device of claim 16, wherein the epoxy is deposited to form the second layer after the third layer is disposed on the first layer.
